(19) United States
(12) Patent Application Publication
(10) Pub. No.: US 2014/0291993 A1
(43) Pub. Date: Oct. 2, 2014

(54) METHOD FOR OPERATING LEAN FUEL INTAKE GAS TURBINE ENGINE, AND GAS TURBINE POWER GENERATION DEVICE

(71) Applicant: KAWASAKI JUKOGYO KABUSHIKI KAISHA, Kobe-shi (JP)

(72) Inventors: Kazuya MATSUO, Kobe-shi (JP); Takehiro YOSHIHARA, Kakogawa-shi (JP); Tsuyoshi KOGA, Kakogawa-shi (JP); Tomoyuki KOMAI, Kobe-shi (JP); Yoshihiro YAMASAKI, Kobe-shi (JP); Shinichi KAJITA, Kobe-shi (JP)

(73) Assignee: KAWASAKI JUKOGYO KABUSHIKI KAISHA, Kobe-shi (JP)

(21) Appl. No.: 14/307,985

(22) Filed: Jun. 18, 2014

Related U.S. Application Data
(63) Continuation of application No. PCT/JP2012/080972, filed on Nov. 29, 2012.

(30) Foreign Application Priority Data
Dec. 22, 2011 (JP) 2011-280949

(51) Int. Cl. F02C 9/00; H02P 9/00

(52) U.S. Cl. CPC F02C 9/00; H02P 9/008; H02P 2201/01
USPC 290/40 R

(57) ABSTRACT

A method for stably operating a lean fuel intake gas turbine engine by controlling the rotation speed of the lean fuel intake gas turbine engine for which it is difficult to control the rotation speed by controlling a fuel flow rate, is provided. In a method for operating a lean fuel intake gas turbine engine (GT) configured to use, as a fuel, a combustible component contained in a low-concentration methane gas to drive a power generator, a power converter (17) is provided between an external electric power system (19) and the power generator (11), and a rotation speed of the power generator (11) is controlled by the power converter (17), to control a rotation speed of the gas turbine engine (GT).

### CROSS REFERENCE TO THE RELATED APPLICATION

This application is a continuation application, under 35 U.S.C. §111(a), of international application No. PCT/JP2012/080972, filed Nov. 29, 2012, which claims priority to Japanese patent application No. 2011-280949, filed Dec. 22, 2011, the disclosure of which are incorporated by reference in their entirety into this application.

### BACKGROUND OF THE INVENTION

1. Field of the Invention

The present invention relates to a method for controlling the rotation speed of a lean fuel intake gas turbine engine which uses, as a fuel, a low-calorie gas such as CMM (Coal Mine Methane) and VAM (Ventilation Air Methane) generated from a coal mine.

2. Description of Related Art

A lean fuel intake gas turbine engine has been proposed which mixes CMM generated from a coal mine with VAM or air or the like and then take the resultant mixture into the engine to combust a combustible component contained therein by a catalytic combustor (e.g., Patent Document 1).

### PRIOR ART DOCUMENT

### Patent Document

[Patent Document 1] JP Laid-open Patent Publication No. 2010-019247

### SUMMARY OF THE INVENTION

In such a gas turbine engine which uses a catalytic combustor, in order to continue stable operation without occurrence of an accidental fire at the combustor, it is necessary to keep the temperature at an inlet of the combustor to be equal to or higher than a reaction temperature. If the rotation speed of the engine is excessively high, the flow rate of gas flowing into the combustor is increased so that it is no longer possible to keep the temperature at the inlet of the combustor. Thus, it is important to control the rotation speed of the engine. However, in a gas turbine which uses a lean fuel, the concentration of the fuel is unstable, and it is difficult to control the rotation speed on the basis of a fuel flow rate. Thus, it is necessary to control the rotation speed by other means.

Therefore, an object of the present invention is to provide, in order to solve the above-described problem, a method for stably operating a lean fuel intake gas turbine engine by controlling the rotation speed of the lean fuel intake gas turbine engine for which it is difficult to control the rotation speed by controlling a fuel flow rate; and a gas turbine power generation device using the method.

In order to achieve the above-described object, a method for operating a lean fuel intake gas turbine engine according to the present invention is a method for operating a lean fuel intake gas turbine engine configured to use, as a fuel, a combustible component contained in a low-concentration methane gas to drive a power generator, the method including: providing a power converter between an external electric power system and the power generator; and controlling a rotation speed of the power generator by the power converter to control a rotation speed of the gas turbine engine.

According to this configuration, it is possible to control the rotation speed of the gas turbine engine without being affected by an unstable fuel concentration of a lean fuel or the frequency of the external electric power system. Thus, it is made possible to keep the temperature of the combustor at an appropriate value, thereby stably operating the lean fuel gas turbine engine.

In one embodiment of the present invention, the operating method may include: providing, in the gas turbine engine, a main combustor to combust a compressed gas compressed by a compressor and supply the resultant gas to a turbine, a heat exchanger to heat the compressed gas by utilizing an exhaust gas from the turbine as a heating medium, and an auxiliary combustor to warm up the heat exchanger during a period from a startup of the gas turbine engine and before a temperature of the main combustor attains a predetermined temperature; and controlling the rotation speed of the gas turbine engine to a warming-up operation rotation speed, which is lower than a rated rotation speed, under a warming-up operation state before the temperature of the main combustor attains a predetermined value. According to this configuration, it is made possible to control the rotation speed of the engine with a simple configuration without adding a drive device such as a starter motor for the warming-up operation, thereby keeping the temperature of the combustor.

In one embodiment of the present invention, the operating method may include: after the temperature of the main combustor attains the predetermined value, stopping operation of the auxiliary combustor and increasing the rotation speed of the gas turbine engine to cause the gas turbine engine to shift to a steady operation state; and controlling the rotation speed of the power generator in the steady operation state, to maintain a temperature at an inlet of the main combustor at a predetermined operating temperature. According to this configuration, even at the time of the steady operation, it is made possible to control the rotation speed such that the temperature of the main combustor is preferentially maintained, without being restricted by the frequency of the external electric power system.

In one embodiment of the present invention, the operating method may include: after end of a steady operation of the gas turbine engine, performing a turning operation in which the gas turbine engine is rotated at a rotation speed lower than a predetermined value. According to this configuration, it is possible to control the rotation speed of the engine with a simple configuration without adding a motor for the turning operation, thereby preventing bending of the rotary shaft after end of operation.

A gas turbine power generation device according to the present invention includes: a lean fuel intake gas turbine engine configured to use, as a fuel, a combustible component contained in a low-concentration methane gas; a power generator connected to the lean fuel intake gas turbine engine via a rotary shaft and driven by the engine; a power converter provided between the power generator and an external electric power system; and a rotation speed control circuit configured to control a rotation speed of the power generator via the power converter, thereby controlling a rotation speed of the gas turbine engine. According to the power generation device, it is possible to control the rotation speed of the gas turbine engine without being affected by an unstable fuel concentration of a lean fuel or the frequency of the external electric power system. Thus, it is made possible to keep the temperature of the combustor at an appropriate value, thereby stably operating the lean fuel gas turbine engine.

Any combination of at least two constructions, disclosed in the appended claims and/or the specification and/or the accompanying drawings should be construed as included within the scope of the present invention. In particular, any combination of two or more of the appended claims should be equally construed as included within the scope of the present invention.

### BRIEF DESCRIPTION OF THE DRAWINGS

In any event, the present invention will become more clearly understood from the following description of embodiments thereof, when taken in conjunction with the accompanying drawings. However, the embodiments and the drawings are given only for the purpose of illustration and explanation, and are not to be taken as limiting the scope of the present invention in any way whatsoever, which scope is to be determined by the appended claims. In the accompanying drawings, like reference numerals are used to denote like parts throughout the several views, and:

FIG. 1 is a block diagram showing a schematic configuration of a gas turbine power generation device according to an embodiment of the present invention;

FIG. 2 is a schematic diagram showing the operating principle of the power generation device in FIG. 1; and

FIG. 3 is a graph showing an example of controlling the rotation speed of a gas turbine engine in the power generation device in FIG. 1.

### DESCRIPTION OF EMBODIMENTS

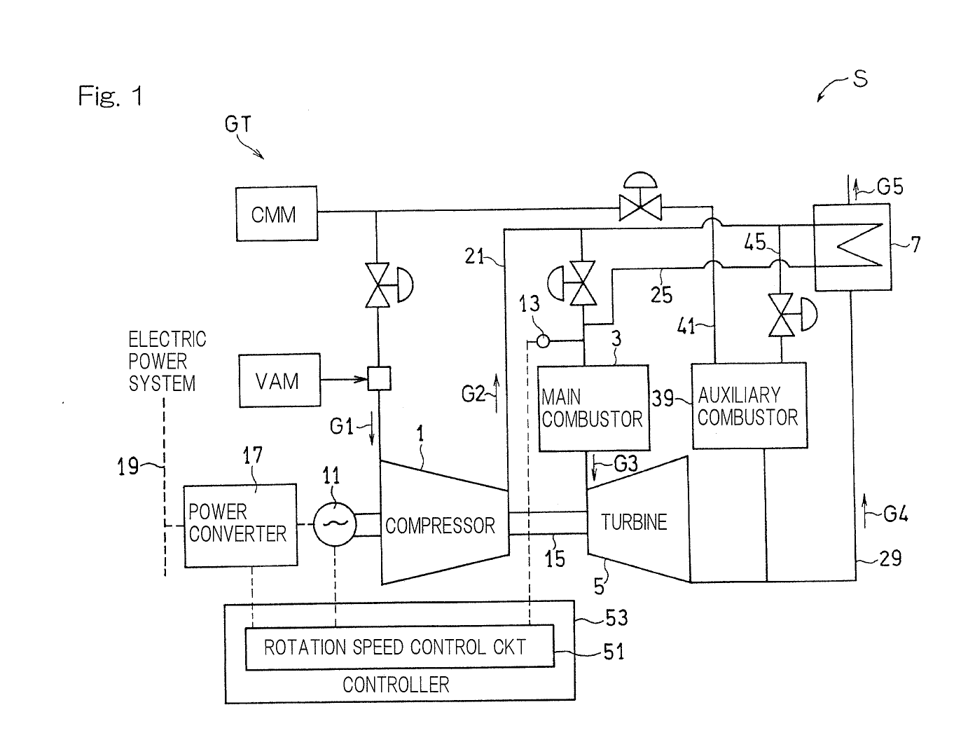

Hereinafter, embodiments of the present invention will be described with reference to the drawings. FIG. 1 is a schematic configuration diagram showing a gas turbine engine GT to be operated by an operating method according to an embodiment of the present invention. The gas turbine engine GT includes, as component elements, a compressor 1, a main combustor 3, a turbine 5, and a heat exchanger 7. The gas turbine engine GT and a power generator 11 which is driven by output of the gas turbine engine GT constitute a gas turbine power generation device (hereinafter, referred to as “power generation device”) S.

The gas turbine engine GT in the present embodiment is configured as a lean fuel intake gas turbine engine which mixes a low-calorie gas, such as CMM (Coal Mine Methane) generated from a coal mine, with air or VAM

(Ventilation Air Methane) discharged from the coal mine to take the resultant mixture into the engine, and uses a combustible component contained therein as a fuel. The main combustor 3 is configured as a catalytic combustor including a catalyst such as platinum, palladium, or the like.

As the low-calorie gas used in the gas turbine engine GT, a working gas G1 obtained by mixing two types of fuel gases having different fuel concentrations such as VAM generated from a coal mine and CMM having a combustible component (methane) concentration higher than that of the VAM is introduced into the gas turbine engine GT through an intake port of the compressor 1. The working gas G1 is compressed by the compressor 1 into a high-pressure compressed gas G2, and the compressed gas G2 is sent to the main combustor 3. The compressed gas G2 is combusted by a catalytic reaction with the catalyst of the main combustor 3 such as platinum, palladium, or the like, and the resulting high-temperature and high-pressure combustion gas G3 is supplied to the turbine 5 to drive the turbine 5. A temperature sensor 13 is provided at an inlet of the main combustor 3.

The turbine 5 is connected to the compressor 1 and the power generator 11 via a rotary shaft 15, and the compressor 1 and the power generator 11 are driven by the turbine 5. An induction power generator is used as the power generator 11. The power generator 11 is connected to an external electric power system 19 via a power converter 17 which constitutes the power generation device S. The power converter 17 includes a circuit incorporated therein for mutual conversion between direct-current power and alternating current power, through which bi-directional power supply between the power generator 9 and the electric power system 19 may be performed.

The heat exchanger 7 heats the compressed gas G2 introduced from the compressor 1 into the main combustor 3, by using a turbine exhaust gas G4 discharged from the turbine 5. The compressed gas G2 from the compressor 1 is sent through a compressed gas passage 21 to the heat exchanger 7, is heated in the heat exchanger 7, and then is sent through a high-temperature compressed gas passage 25 to the main combustor 3. The turbine exhaust gas G4 having flowed through the main combustor 3 and the turbine 5 flows through a turbine exhaust gas passage 29 into the heat exchanger 7. An exhaust gas G5 discharged from the heat exchanger 7 passes through a silencer, which is not shown, to be silenced, and then is released to the outside.

In addition to the main combustor 3, the gas turbine engine GT includes an auxiliary combustor 39. This auxiliary combustor 39 is used to warm up the heat exchanger 7 by supplying a high temperature combustion gas to the heat exchanger 7, during a period from the startup of the gas turbine engine GT and before the main combustor 3 attains a predetermined working temperature, for example, 400° C. The auxiliary combustor 39 receives a fuel (for example, the CMM in the illustrated embodiment) supplied from an exclusive fuel supply passage 41, as well as an air supplied from a starter air extraction passage 45 ramified from the compressed gas passage 21.

The power generation device S, having such a configuration, is provided with a rotation speed control circuit 51 for controlling with respect to the gas turbine engine GT the rotation speed of the power generator 11 by the power converter 17, thereby controlling the rotation speed of the engine. The rotation speed control circuit 51 is included in a controller 53 which controls the entirety of the gas turbine engine GT.

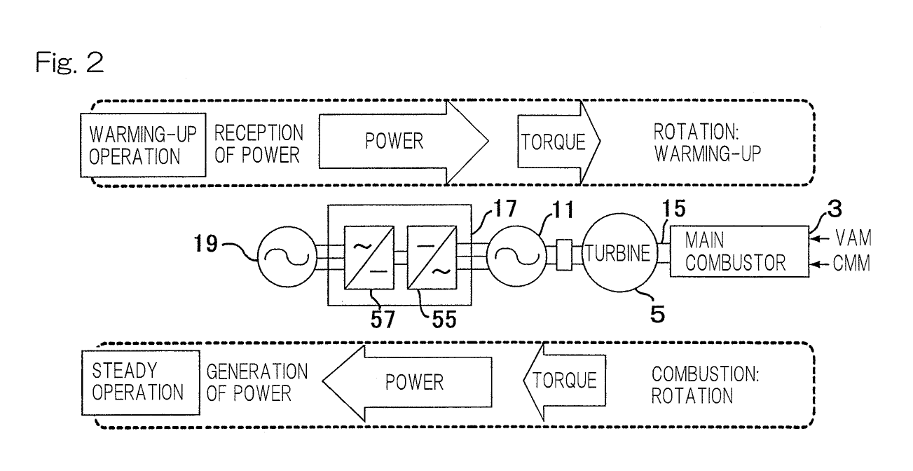

FIG. 2 schematically shows the principle of controlling the rotation speed of the gas turbine engine GT by using the power converter 17 in the present embodiment. The power converter 17 includes an inverter 55 connected to the power generator 11 and a converter 57 connected to the external electric power system 19. At the time of startup of the gas turbine engine GT, the power generator 11 receives electric power supplied from the external electric power system 19 via the power converter 17 to thereby serve as an electric motor, and a warming-up operation of the gas turbine engine GT is performed.

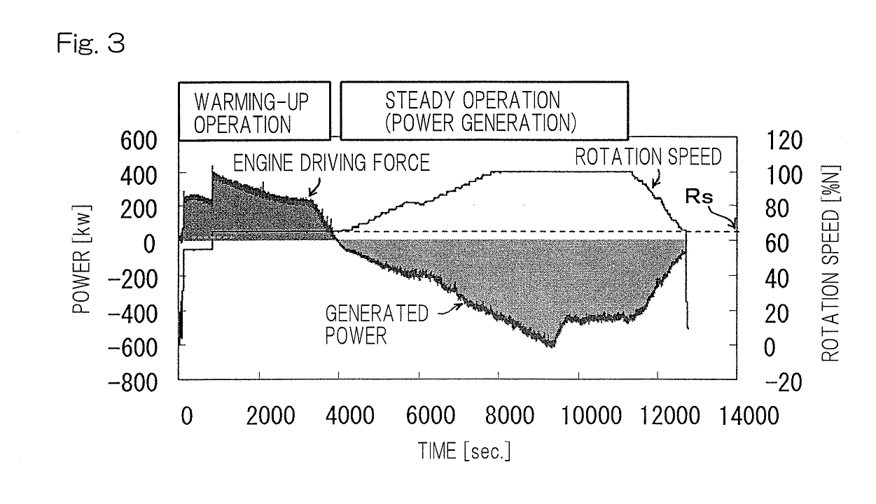

In the warming-up operation, if the rotation speed is excessively increased, the flow rate of gas flowing into the main combustor 3 becomes excessive and the temperature of the main combustor 3 is decreased. Thus, it is necessary to maintain the rotation speed at a predetermined warming-up operation rotation speed. Therefore, during the warming-up operation, the rotation speed of the power generator 11 is controlled via the power converter 17, thereby controlling the rotation speed of the gas turbine engine GT such that the rotation speed of the gas turbine engine GT is maintained at a warming-up operation rotation speed Rs (65% of a rated rotation speed in this example) which is lower than the rated rotation speed, as shown in FIG. 3. During the warming-up operation, the auxiliary combustor 39 shown in FIG. 1 receives the fuel and supplies the high-temperature combustion gas the heat exchanger 7 to warm up the heat exchanger 7. The warming-up operation is continued until the temperature of the main combustor 3 attains a predetermined value.

After a temperature at the inlet of the main combustor 3 which is measured by the temperature sensor 13 attains the predetermined operating temperature, for example, 400° C., operation of the auxiliary combustor 39 is stopped, and the gas turbine engine GT shifts to a steady operation shown in FIG. 3. In other words, sufficient output for the power generator 11 is obtained from the gas turbine engine GT, and the power generator 11 comes into an power generation state and supplies power to the external electric power system 19 via the power converter 17. In this steady operation state, the inverter 55 of the power converter 17 is controlled to increase the rotation speed of the power generator 11, thereby increasing the rotation speed of the gas turbine engine GT.

Even after the gas turbine engine GT shifts to the steady operation, the flow rate of the compressed gas G2 supplied to the main combustor 3 changes depending on the rotation speed, and hence the temperature of the main combustor 3 also changes. Accordingly, the rotation speed of the gas turbine engine GT is controlled by the rotation speed control circuit 51 such that the temperature at the inlet of the main combustor 3 is maintained at the predetermined operating temperature. In other words, depending on an operating state of the gas turbine engine GT, the gas turbine engine GT is controlled so as to operate at a rotation speed which is lower than the rated rotation speed. Since the rotation speed of the gas turbine engine GT is controlled by controlling the rotation speed of the power generator 11 by using the rotation speed control circuit 51 as described above, it is made possible to control the rotation speed of the gas turbine engine GT such that the temperature of the main combustor 3 is preferentially maintained at the predetermined value, without being restricted by the frequency of the external electric power system 19.

In addition, after end of operation of the gas turbine engine GT, in order to remove bending (bending deformation) of the rotary shaft 15, it is necessary to perform turning in which the rotary shaft 15 is turned at a very low turning speed for a long time period (e.g., 10 hours). In the present embodiment, it is possible to perform the turning by means of rotation speed control performed by the power converter 17. Therefore, it is possible to omit a small-size motor for turning which has been conventionally provided.

As described above, according to the method for controlling the rotation speed of the gas turbine engine GT according to the present embodiment, it is possible to control the rotation speed of the gas turbine engine GT by using the power converter 17 without being restricted by the frequency of the external electric power system 19. Thus, it is made possible to keep the main combustor 3 of the lean fuel intake gas turbine engine, for which it is difficult to control the rotation speed by controlling a fuel flow rate, at a required predetermined temperature. Therefore, it is made possible to stably operate the lean fuel gas turbine engine.

It should be noted that in the present embodiment, the example in which a catalytic combustor is used as the main combustor 3 has been described as the lean fuel intake type gas turbine engine GT, but the present invention is also applicable to the case where another type of a combustor is used.

Although the present invention has been described above in connection with the embodiments thereof with reference to the accompanying drawings, numerous additions, changes, or deletions can be made without departing from the gist of the present invention. Accordingly, such additions, changes, or deletions are to be construed as included in the scope of the present invention.

### REFERENCE NUMERALS

1 . . . Compressor
3 . . . Main combustor
5 . . . Turbine
7 . . . Heat exchanger
11 . . . Power generator
15 . . . Rotary shaft
17 . . . Power converter
19 . . . External electric power system
39 . . . Auxiliary combustor
51 . . . Rotation speed control circuit
GT . . . Gas turbine engine
S . . . Gas turbine power generation device

What is claimed is:

1. A method for operating a lean fuel intake gas turbine engine configured to use, as a fuel, a combustible component contained in a low-concentration methane gas to drive a power generator, the method comprising:
providing a power converter between an external electric power system and the power generator; and
controlling a rotation speed of the power generator by the power converter to control a rotation speed of the gas turbine engine.

2. The method for operating the lean fuel intake gas turbine engine as claimed in claim 1, further comprising:
providing, in the gas turbine engine, a main combustor to combust a compressed gas compressed by a compressor and supply the resultant gas to a turbine, a heat exchanger to heat the compressed gas by utilizing an exhaust gas from the turbine as a heating medium, and an auxiliary combustor to warm up the heat exchanger during a period from a startup of the gas turbine engine and before a temperature of the main combustor attains a predetermined temperature; and
controlling the rotation speed of the gas turbine engine to a warming-up operation rotation speed, which is lower than a rated rotation speed, under a warming-up operation state before the temperature of the main combustor attains a predetermined value.

3. The method for operating the lean fuel intake gas turbine engine as claimed in claim 2, further comprising:
after the temperature of the main combustor attains the predetermined value, stopping operation of the auxiliary combustor and increasing the rotation speed of the gas turbine engine to cause the gas turbine engine to shift to a steady operation state; and
controlling the rotation speed of the power generator in the steady operation state, to maintain a temperature at an inlet of the main combustor at a predetermined operating temperature.

4. The method for operating the lean fuel intake gas turbine engine as claimed in claim 1, further comprising:
after end of a steady operation of the gas turbine engine, performing a turning operation in which the gas turbine engine is rotated at a rotation speed lower than a predetermined value.

5. A gas turbine power generation device comprising:
a lean fuel intake gas turbine engine configured to use, as a fuel, a combustible component contained in a low-concentration methane gas;
a power generator connected to the lean fuel intake gas turbine engine via a rotary shaft to be driven by the engine;
a power converter provided between the power generator and an external electric power system; and
a rotation speed control circuit configured to control a rotation speed of the power generator via the power converter, thereby controlling a rotation speed of the gas turbine engine.
